(19) United States
(12) Patent Application Publication
(10) Pub. No.: US 2004/0246196 A1
(43) Pub. Date: Dec. 9, 2004

(54) Antenna unit

(76) Inventors: Junichi Noro, Akita (JP); Yuichi Saito, Akita (JP); Kyuichi Sato, Akita (JP)

Correspondence Address: WHITHAM, CURTIS & CHRISTOFFERSON, P.C., SUITE 340, 11491 SUNSET HILLS ROAD, P.O. BOX 9204, RESTON, VA, 20190, US

(21) Appl. No.: 10/785,935

(22) Filed: Feb. 26, 2004

(30) Foreign Application Priority Data
Jun. 3, 2003 (JP) P. 2003-157582

(51) Int. Cl. H01Q 1/42

(52) U.S. Cl. 343/872

(57) ABSTRACT

To provide new attachment structure of a gasket which can surely prevent entry of water without fear of the mischief and is superior in appearance

An antenna unit includes an antenna module which receives radio waves transmitted from a satellite, a cover member which has inner space of size enough to house the antenna module and has an opened bottom surface, and a bottom plate which closes the opened bottom surface of the cover member, wherein a gasket which covers at least a periphery of the bottom plate is arranged, and this gasket comes into contact with the inner surface of the cover member thereby to seals the inner space. Since the gasket does not have a cover portion which covers the outer surface of the cover member, lowering of waterproof function caused by such mischief that this cover portion is pulled by a hand can be prevented, and simultaneously a fine appearance is secured.

### BACKGROUND OF THE INVENTION

1. Field or the Invention

The present invention relates to an antenna unit which receives radio waves transmitted from a satellite, and particularly to an antenna unit suitable for a car antenna attached onto an automotive roof.

2. Description of the Related Art

A system which leads and guides a driver of a car to a course of its car, that is, a car navigation system has been prevailed. In such the car navigation system, the present position is specified by speed and running distance of the car, while, in order to improve accuracy of position, radio waves transmitted from a GPS (global positioning system) satellite are received and the present position is specified also by the position data obtained from the received radio waves.

Recently, in the USA, it has been promoted to provide digital radio broadcasting by radio waves transmitted from an earth satellite. Also, in a digital radio receiving system which receives such the digital radio broadcasting, an antenna for receiving radio waves transmitted from the satellite is still required, and a so-called satellite radio broadcasting reception antenna is used.

The radio wave from the satellite, since a high-frequency band is used, has high directivity. Accordingly, in the car navigation system and the digital radio receiving system, in order to receive the radio waves from the satellite in a good reception state, it is necessary to attach a reception antenna onto a top surface (i.e., roof) of the car. Therefore, for the antenna unit for receiving the radio waves from the satellite, high atmospheric corrosion resistance and waterproof property are necessary.

As a conventional waterproof countermeasure in this kind of antenna unit, it is general to use a gasket (packing) composed of rubber, and attachment structure as shown in FIG. 6 is widely adopted. Namely, a bottom surface of a cover member 101 in which an antenna module for receiving radio waves transmitted from the satellite is housed is sealed by a bottom plate 103 to which a gasket 102 is attached, and the antenna unit is set onto a roof panel 104 of a car thereby to prevent entry of water. At this time, as shown in FIG. 7, a slit 102a is provided for the gasket 102 thereby to provide double structure, and an end 101a on the bottom side of the cover member 101 is inserted into this slit 102a thereby to secure the sealing state.

However, in case that the aforesaid waterproof structure is adopted, the surroundings near the bottom surface of the cover member 101 are covered with a cover part 102b of the gasket 102 like a skirt, and such mischief that this skirt-like portion is pulled by a hand has been frequently reported. In case that the cover part 102 of the gasket 102 is pulled, there is fear that a waterproof function is damaged, which is a large problem.

Further, the state in which the surroundings near the bottom surface of the cover member 101 are covered with the cover part 102b like the skirt mare the appearance greatly. Further, also from a viewpoint of the waterproof function, there is a problem that water easily enters the inside of the cover member 101 from a gap between the cover part 102b and the cover member 101, and improvement of this problem is desired.

### SUMMARY OF THE INVENTION

The invention, in view of such the conventional circumstances, has been proposed, and it is an object of the invention to provide new attachment structure of a gasket which can surely prevent entry of water without fear of the mischief and is superior in appearance thereby to provide an antenna unit which is high in reliability.

In order to achieve the above object, an antenna unit according to the invention includes an antenna module which receives radio waves transmitted from a satellite or the earth, a cover member which has inner space of size enough to house the antenna module and has an opened bottom surface, and a bottom plate which closes the opened bottom surface of the cover member, and the antenna unit is characterized in that a gasket which covers at least a periphery of the bottom plate is arranged, and this gasket comes into contact with the inner surface of the cover member thereby to seals the inner space.

In the antenna unit of the invention, the gasket is built into the bottom surface side of the cover member, and the gasket comes into contact the inner surface of the cover member thereby to prevent entry of water. Therefore, since the cover part which covers the outer surface of the cover member does not exist, the mischief of pulling this cover part is prevented. Simultaneously, the fine appearance is also secured. Further, since a boundary portion between the cover member and the gasket does not face to the outside, there is no rear that the water enters the inside of the cover member from the gap between the cover member and the gasket.

### BRIEF DESCRIPTION OF THE DRAWINGS

FIG. 1 is a side view showing one example of an antenna unit to which the invention is applied.

FIG. 2 is a side view showing the exploded antenna unit to which the invention is applied.

FIG. 3 is a main portion sectional view showing an enlarged seal portion between a cover member and a gasket.

FIG. 4 is a bottom view of the antenna unit to which the invention is applied.

FIG. 5 is a top view of a bottom plate in the antenna unit to which the invention is applied.

FIG. 6 is a side view showing a conventional antenna unit.

FIG. 7 is a main portion sectional view showing an enlarged seal portion between a cover member and a gasket in the conventional antenna unit.

### DESCRIPTION OF THE PREFERRED EMBODIMENTS

An antenna unit to which the Invention is applied will be described below in detail with reference to drawings.

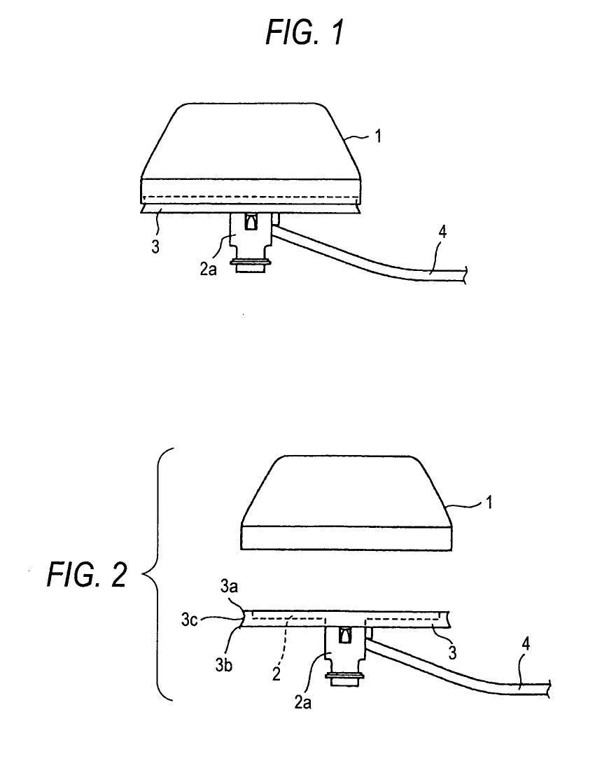

An antenna unit in this embodiment, as shown in FIGS. 1 and 2, comprises an antenna module (not shown) which receives radio waves transmitted from a satellite, a cover member 1 which has inner space of size enough to house the antenna module and has an opened bottom surface, a bottom plate 2 which closes the opened bottom surface of the cover member, and a gasket 3 which covers a periphery and a bottom surface of this bottom plate 2.

The gasket 3 arranged so as to cover the periphery of the bottom plate 2 comes into contact with the inner surface of the cover member 1 thereby to seal the inner space in which the antenna module is housed. The bottom plate 2 to which the gasket 3 has been attached is attached to the cover member 1 so as to be built into the opened bottom surface of the cover member 1. As shown in FIG. 1, when the antenna unit has been attached to an automotive proof, the gasket 3 can be hardly seen from the outside.

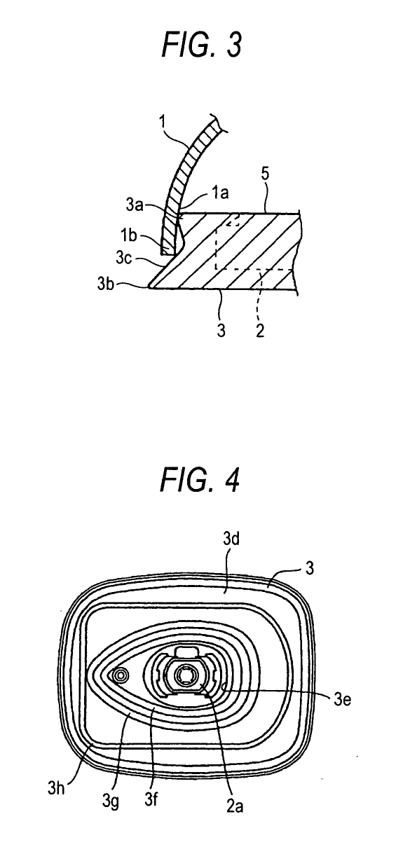

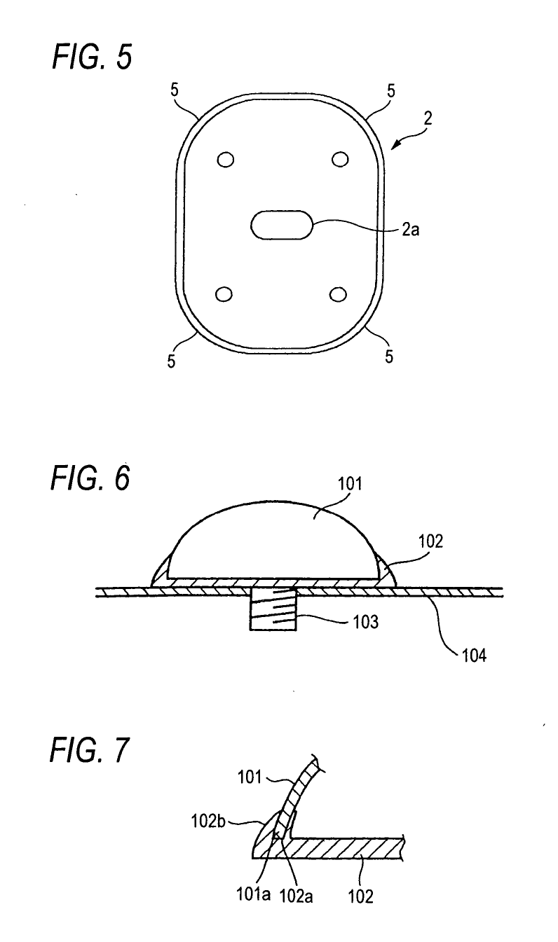

In the gasket 3, as shown in FIG. 2, an upper end 3a and a lower end 3b in the thickness direction of the bottom plate 2 are larger in dimension than other portions, and an external dimension W1 of the lower end 3b is set larger a little than an opening dimension W2 of the opened bottom surface of the cover member 1. Further, the lower end 3b side of the gasket 3 is a slant surface 3c which becomes larger in dimension toward the lower end 3b. Further, as shown in FIGS. 3 and 5, the bottom plate 2 has a different-in-level portion 5 at the entire periphery of its edge, and the gasket 3 is attached to the bottom plate 2 and held so that an edge portion of the gasket 3 covers the different-in-level portion 5.

Therefore, in case that the bottom plate 2 to 5 which the gasket 3 has been attached is pushed into the opened bottom surface of the cover member 1, as shown in FIG. 3 of an enlarged view, the upper end 3a of the gasket 3 is brought into pressure-contact with the inner surface 1a of the cover member 1, and the lower end edge 1b of the cover member is brought into contact with the slant surface 3c. Hereby, at two positions, that is, at the position where the lower end edge 1b of the cover member 1 comes into contact with the slant surface 3c and at the position where the upper end 3a of the gasket 3 is brought into pressure-contact with the inner surface 1a of the cover member 1a, the inner apace of the cover member is sealed. Therefore, the inner space is sealed double and it is possible to prevent water from entering the inside of the cover member 1 surely.

Further, the gasket 3 has a setting surface 3d which covers the bottom surface of the bottom plate 2. When the antenna unit is attached onto an automotive proof, this setting surface 3d is interposed between the bottom plate 2 and the automotive proof and functions as packing. At this time, at the bottom plate 2, a boss 2a for leading the connection cable into a car room is formed. As shown in FIG. 4, correspondingly to the boss 2a, an opening portion 3e is formed in the setting surface 3d. Accordingly, there is fear of entry of the water from this opening portion 3e.

Therefore, in the embodiment, on the setting surface 3d, plural ring protrusions are formed so as to surround the opening portion 3e of the setting surface 3d, and herein a triple protrusion 3f, 3g, 3h is formed thereby to prevent entry of the water from this opening portion 3e. Namely, the opening portion 3e of the setting surface 3d is sealed threefold by attaching these protrusions 3f, 3g and 3h onto the automotive proof closely, whereby the water is surely prevented from entering the inside of the cover member 1 from this opening portion 3e.

As clear from the above description, in the antenna unit of the invention, the gasket is built into the bottom surface of the cover member, and the cover portion which covers the outer surface of the cover member does not exist. Therefore, such mischief that this cover portion is pulled by a hand can be surely prevented. Accordingly, it is possible to prevent deterioration or waterproof property caused by the mischief, and this gasket attachment structure is very effective for prevention of the mischief.

Further, absence of the cover portion which covers the outer surface of the cover member provides a large merit on appearance. Further, since the gasket can be hardly seen from the outside, in case that the antenna unit has been attached onto the automotive proof, the appearance is not marred.

Further, in the antenna unit of the invention, the inner space of the cover member is double sealed by the peripheral edge portion of the gasket, and the boundary portion between the cover member and the gasket does not face to the outside. Therefore, there is no fear that the water enters the inside of the cover member from the gap between the cover member and the gasket, and good waterproof property and atmospheric corrosion resistance can be given, so that it is possible to provide the antenna unit which is high in reliability

What is claimed is:

1. An antenna unit comprising;
an antenna module:
a cover, formed with an inner face and an opening which define an opened inner space for housing the antenna module; and
a lid member, comprising a gaskets the lid member closes the opened inner space such that the gasket is brought into contact with only the inner face.

2. The antenna unit according to claim 1, wherein:
the inner face comprises a first part and a second part;
the lid member comprises a fist part brought into contact with the first part of the inner faces and a second part brought into contact with the second part of the inner face.

3. The antenna unit according to claim 2,
wherein:
the lid member comprises a mounting face to be opposed to an object face on which the antenna unit is mounted;
the cover comprises an edge which defines the opening:
an outer dimension of the gasket is enlarged toward the mounting face while forming aslant face; and
the edge of the cover is brought into contact with the slant face.

4. The antenna unit according to claim 1, further comprising:
a cable, electrically connected with the antenna module, wherein:
the lid member comprises an opening through which the cable is led out and a mounting face to be opposed to an object face on which the antenna unit is mounted; and
the lid member comprises plural annular protrusions surrounding the opening of the lid member which are to be brought into contact with the object face.

5. The antenna unit according to claim 1, wherein the lid member comprises a bottom plate formed with a step portion at an outer periphery thereof, and the gasket is attached to the bottom plate while covering the step portion.
